(19) United States
(12) Patent Application Publication
(10) Pub. No.: US 2006/0001243 A1
(43) Pub. Date: Jan. 5, 2006

(54) Golf bag with retractable wheels

(76) Inventor: Yung-Ho Hsu, An Ding Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/882,198

(22) Filed: Jul. 2, 2004

(51) Int. Cl. B62B 1/00

(52) U.S. Cl. 280/652

(57) ABSTRACT

A golf bag with retractable wheels includes a golf bag, retractable mechanisms, wheels and a supporting rod. The golf bag comprises a pair of recesses at respective bottom sides to accommodate the retractable mechanisms and the wheels. Each retractable mechanism has one end connected to one relative wheel, while the other end of which is secured to the bottom of the golf bag. Thus, the wheels may be extended outwardly from the recesses of the golf bag for strolling, and the supporting rod is able to support the golf bag standing still when not in moving.

### BACKGROUND OF THE INVENTION

1. Filed of the Invention

This invention relates to a golf bag with retractable wheels, and more particularly to the wheels that are adjustable in position for storage and for pulling along the golf course.

2. Description of the Prior Art

People like to play golf for its mild exercise and to breathe healthy air. However, the golf bag is always a headache to golfers for the inconvenience of carrying around. Therefore, some people use caddies to carry their bags.

Some people would prefer to carry the bag themselves when they are playing the game with friends or for leisure. In order for golfers to carry their bags easily, golf bag carts and wheeled golf bags are developed. A golf cart is to put a golf bag on a tri-wheel cart and pushed around the golf course. This golf cart has a large size, which is not easy to carry for a golfer. The other wheeled golf bag is to secure a pair of wheels to the golf bag so that the golfer can pull the golf bag when walking. These wheels are fixed to the golf bag. That takes space in storage and may bump to the objects in a car trunk or storage room.

In view of these, the inventor has derived the present invention to improve the above-mentioned shortcomings.

### SUMMARY OF THE INVENTION

It is the primary objective of the present invention to provide a golf bag with retractable wheels, which is easy to operate.

It is another objective of the present invention to provide a golf bag with retractable wheels, which saves space in storage.

It is a further objective of the present invention to provide a golf bag with retractable wheels, which is cost effectiveness.

### BRIEF DESCRIPTION OF THE DRAWINGS

FIG. 1 is a perspective view of the present invention;

FIG. 2 is a perspective view of a pair of retractable mechanisms of the present invention;

FIG. 3 is an enlarged portion view of locating troughs of the retractable mechanism of the present invention;

FIG. 4 is an enlarged top view of FIG. 2, partial sectioned;

FIG. 5 is an enlarged view of a safety pin of the present invention, partially sectioned;

FIG. 5A is an enlarged view of a rectangular section of the safety pin of the present invention; and

FIG. 6 is a top view of the present invention, partial sectioned.

### DETAILED DESCRIPTION OF THE PREFERRED EMBODIMENT

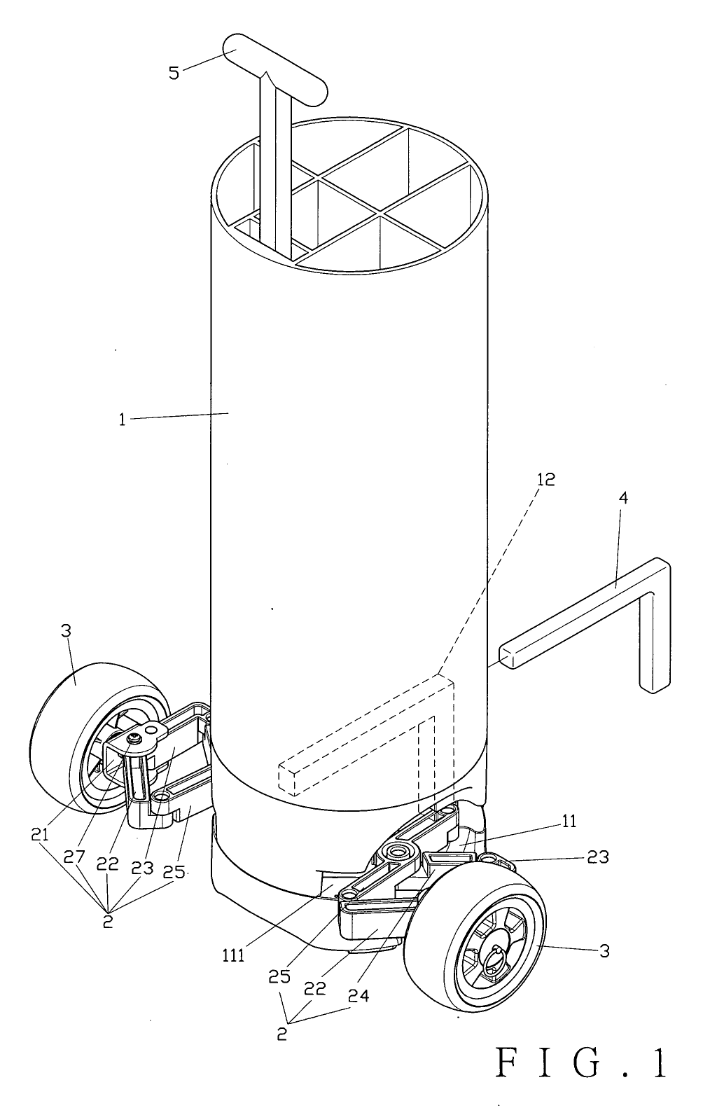

As shown in FIG. 1, the present invention comprises a golf bag 1, a pair of retractable mechanisms 2, two wheels 3, a supporting rod 4 and a handle 5.

The golf bag 1 has a pair of recesses 11 at respective bottom sides adapted to accommodate the retractable mechanisms 2 and the wheels 3 therein. Each recess 11 comprises a long trough 111 at the inner wall for the retractable mechanism 2 to slide along therein. A groove 12 is formed at the lower portion of the golf bag 1 to receive the supporting rod 4 therein. A handle 5 is set on the top of the golf bag 1 for pulling purpose.

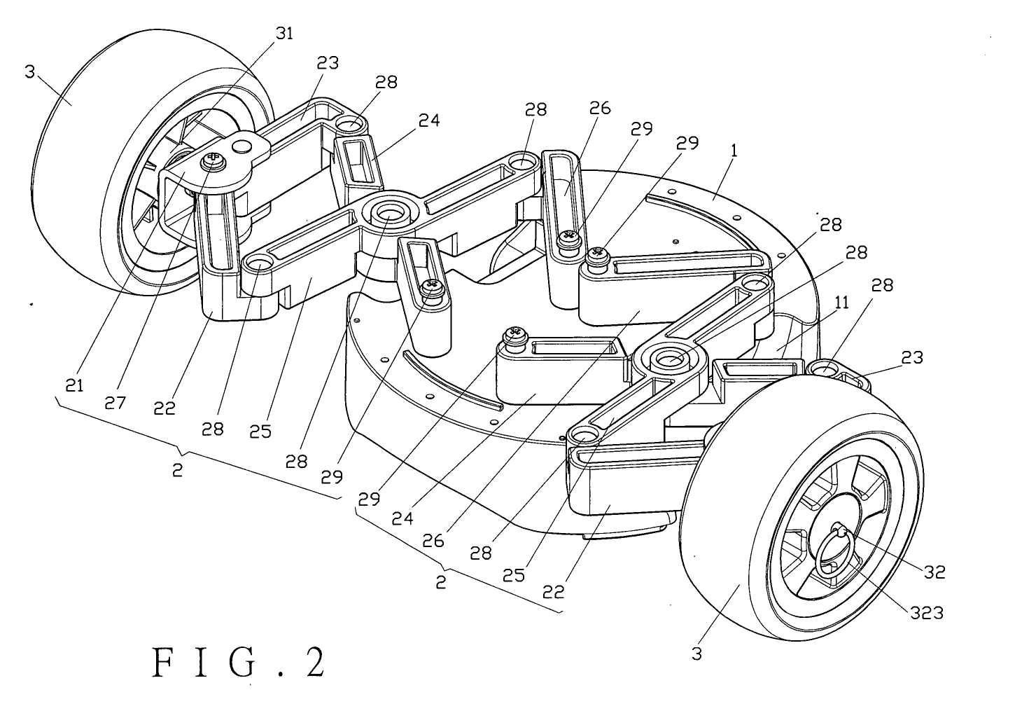

Each retractable mechanism 2, as shown in FIG. 2, includes a bracket 21, first, second and third L-shaped rods 22, 23, 26, two linking rods 24 and 25, one short pin 27, four rivets 28, two long pins 29. The bracket 21 is secured to a relative wheel 3. Each L-shaped rod 22, 23 or 26 has a pair of holes at respective ends. Each linking rod 24 or 25 is formed by a pair of rods and shaped like the sign of a thunder with a hole at the center connecting area.

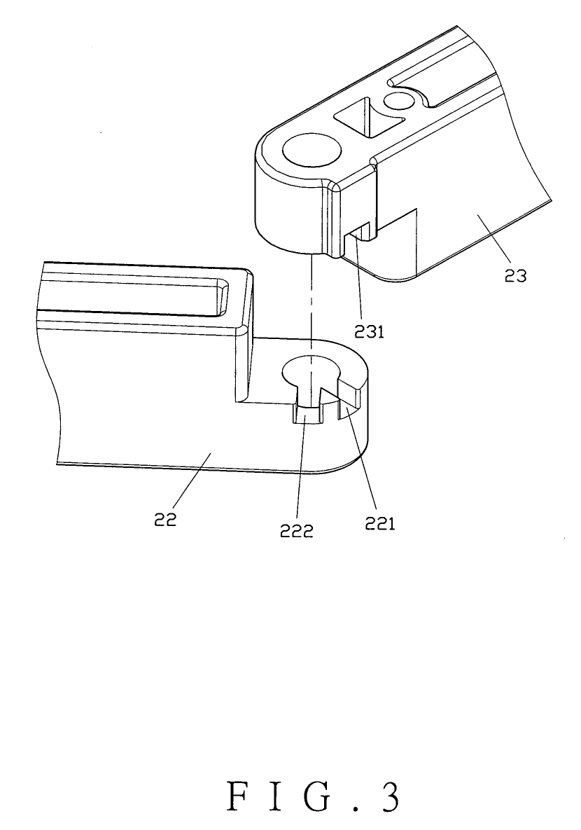

FIG. 3 shows the first and second L-shaped rods 22 and 23 in a separated status. The first L-shaped rod 22 comprises locating troughs 221 and 222, and the second L-shaped rod 23 comprises a locating trough 231 for insertion of a safety pin 32 to secure the wheel 3 and the golf bag 1 at a relative position.

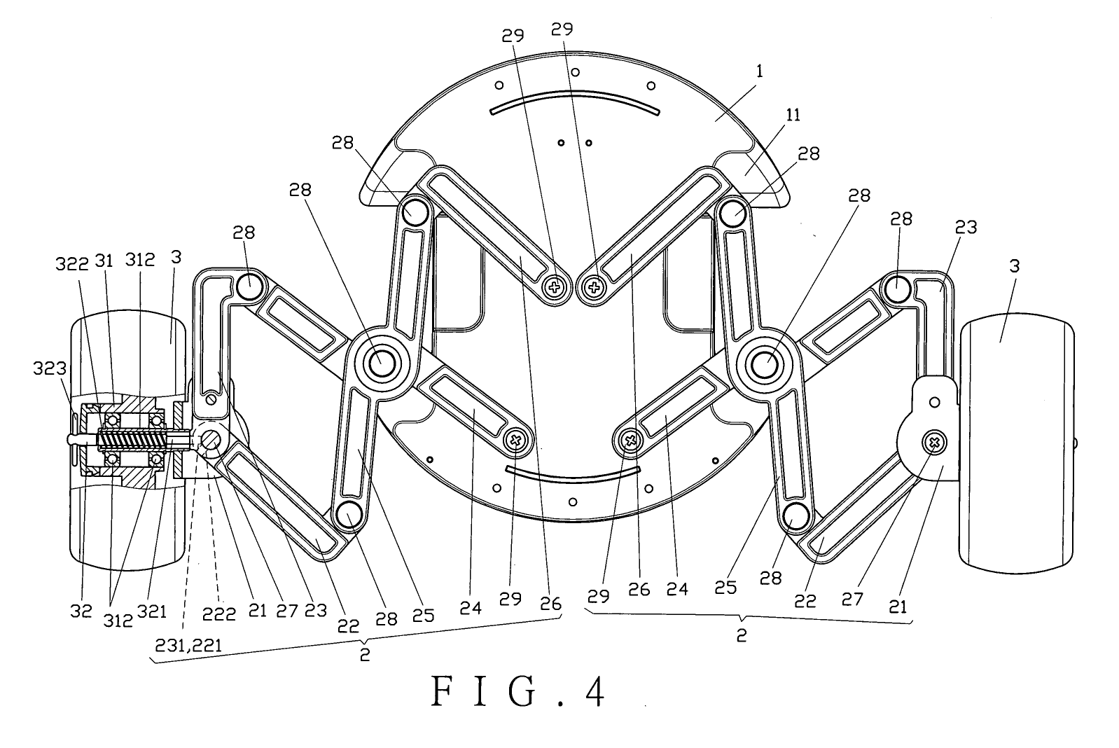

As shown in FIGS. 2 and 4, the bracket 21 connects with one respective end of the first and second L-shaped rods 22 and 23 with the short pin 27, while the other ends of the first and second L-shaped rods 22 and 23 are connected with one end of the linking rods 24 and 25 with the rivets 28, respectively. The linking rods 24 and 25 are connected with each other at the center portion with one rivet 28. The other end of the linking rod 25 is connected to one end of the third L-shaped rod 26 with one rivet 28, while the other end of the linking 24 is connected to the bottom of the golf bag 1 with one long pin 29. The other end of the third L-shaped rod 26 is connected to the bottom of the golf bag 1 with another long pin 29.

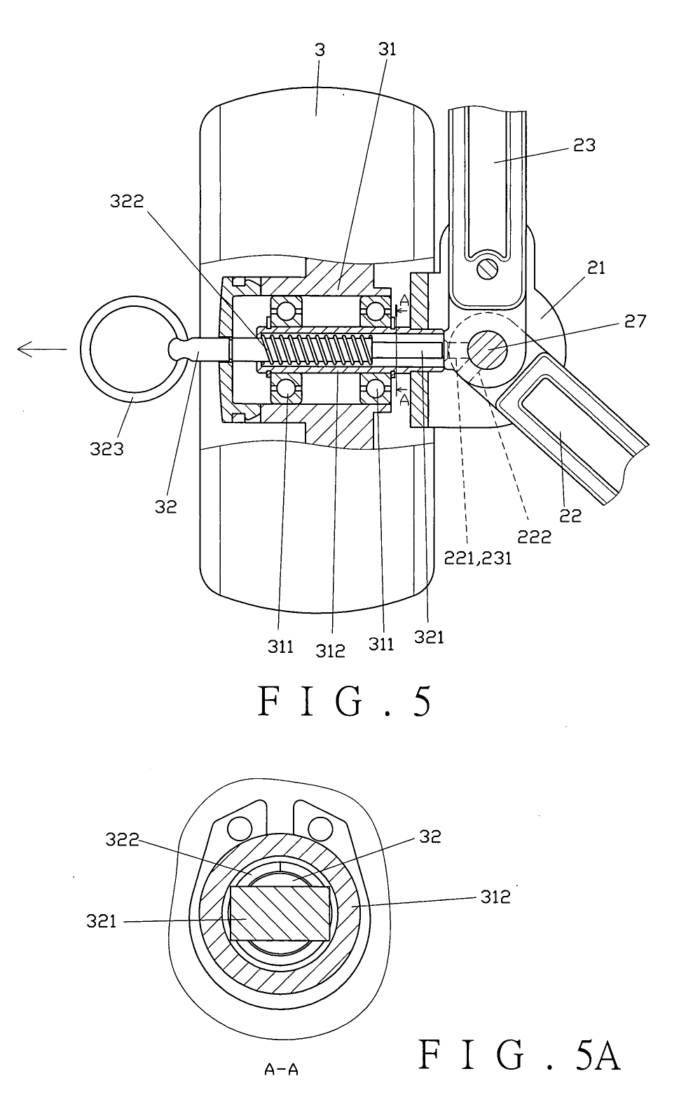

As shown in FIGS. 4, 5 and 5A, each wheel 3 comprises a hub 31 at the inner. The hub 31 comprises a pair of bearings 311 and a sleeve 312 within the bearings 311. The sleeve 312 has one end secured to the bracket 21. The safety pin 32 is inserted in the sleeve 312, and has one rectangular section 321 inserted into the locating troughs 221, 231 or 222, 231 of the first and second L-shaped rods 22 and 23. The other end of the safety pin 32 is a round section sleeved with a spring 322. The spring 322 is restrained on the round section of the safety pin 32 within the sleeve 312. The endmost end of the round section of the safety pin 32 protrudes outwardly from the sleeve 312 and the hub 31, and is secured with a ring 323 thereat.

By pulling the ring 323 outwardly, the safety pin 32 moves with the ring 323, and the rectangular section 321 is detached from the locating troughs 221 and 231 of the first and second L-shaped rods 22 and 23. The L-shaped rods 22, 23, 26 and the linking rods 24, 25 of the retractable mechanisms 2 are able to extend fully, which brings the wheels 3 outwardly away from the recesses 11. The weight of the golf bag 1 also helps the retractable mechanisms 2 to extend fully. The spring 322 forces the rectangular section 321 of the safety pin 32 to insert into the locating troughs 222 and 231 of the first and second L-shaped rods 22, 23 to secure the retractable mechanism 2 at place. Thus, the golf bag 1 is pulled easily to anywhere at any place. By pulling the supporting rod 4 outwardly, the bag 1 is able to stand still.

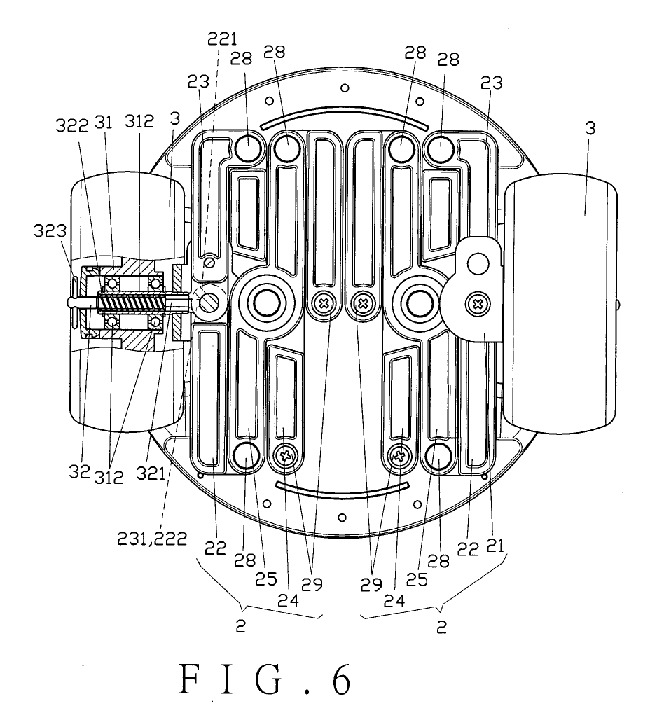

When traveling, the wheels 3 and the supporting rod 4 may be retracted into the recesses 11 and the groove 12. By pulling the ring 323 to bring the safety pin 32 away, the wheels 3 are pushed towards the recesses 11 to retract the L-shaped rods 22, 23, 26, and the linking rods 24, 25. Thus, the wheels 3 and the retractable mechanisms 2 are collapsed into the recesses 11, as shown in FIG. 6.

I claim:

1. A golf bag with retractable wheels comprising a golf bag, a pair of retractable mechanisms, and wheels, said golf bag comprising a pair of recesses at respective bottom sides to accommodate said wheels and said retractable mechanisms therein, each said retractable mechanism having one end secured to a bottom of said golf bag and another end secured to one relative wheel, thus said wheels being controlled by said retractable mechanisms to collapse within said recesses or to extend outwardly from said recesses.

2. The golf bag with retractable wheels, as recited in claim 1, wherein each said retractable mechanism comprises a bracket, first, second and third L-shaped rods, two linking rods, said bracket being secured to one relative wheel and connecting with one end of said first and second L-shaped rods, respectively, the other ends of said first and second L-shaped rods being connected with one end of said linking rods, respectively, said linking rods being connected with each other at a center connecting area thereof, the other end of one of linking rods being connected to the bottom of said golf bag while the other end of other said linking rod being connected with one end of said third L-shaped rod, the other end of said third L-shaped rod being connecting to the bottom of the golf bag.

3. The golf bag with retractable wheels, as recited in claim 2, wherein each said L-shaped rod has a pair of holes at respective ends, each said linking rod is formed by a pair of rods and shaped like the sign of a thunder with a hole at the center connecting area.

4. The golf bag with retractable wheels, as recited in claim 1, wherein said first and second L-shaped rods comprise locating troughs, each said wheel is mounted with a safety pin, said safety pin having a rectangular section inserted into said locating troughs of said first and second L-shaped rods to secure said wheel and said golf bag at a relative position.

5. The golf bag with retractable wheels, as recited in claim 4, wherein each said wheel comprises a hub at an inner, said hub comprising two bearings and a sleeve within said bearings, said sleeve having one end secured to said bracket, said safety pin being inserted in said sleeve, another end of said safety pin being a round section sleeved with a spring, an endmost end of said round section of said safety pin protruding outwardly from said sleeve and said hub and being connected with a ring thereat.

6. The golf bag with retractable wheels, as recited in claim 1, wherein said golf bag comprises a supporting rod to sustain said golf bag standing still.
